(19) United States
(12) Patent Application Publication
(10) Pub. No.: US 2005/0108293 A1
(43) Pub. Date: May 19, 2005

(54) Method and apparatus for matter-centric document management

(76) Inventors: L. Keith Lipman, Gladwyne, PA (US); Neil Araujo, Wilmette (IL); Rafiq Mohammadi, Chicago, IL (US); Mohit Mutreja, Naperville, IL (US); Aaron Rangel, North Brook, IL (US)

Correspondence Address: GLENN PATENT GROUP, 3475 EDISON WAY, SUITE L, MENLO PARK, CA, 94025, US

(21) Appl. No.: 10/716,944

(22) Filed: Nov. 18, 2003

(51) Int. Cl. G06F 17/30

(52) U.S. Cl. 707/200

(57) ABSTRACT

A method and apparatus for providing a matter-centric document organization is described.

### FIELD OF THE INVENTION

The present invention relates to document management, and more particularly to providing matter-centric document management.

### BACKGROUND

Document management is becoming important in all environments. Documents are received and created in multiple formats, such as word-processing documents, faxes, emails, etc. In general, in organizations such as law offices, physical documents are arranged by matter. Matters identify a particular case, issue, theme, or other identification that unites the documents. For example, in law offices, the physical documents are arranged in folders, which contain all documents related to a particular case, or matter. Similarly, in many corporations, documents related to a particular issue are filed together, such as an engagement or project. This type of matter file enables a user to easily identify relevant documents.

In contrast, electronic files are generally filed in the folders provided by an operating system such as Microsoft Windows. These folders generally do not organize the files in any particular order. Rather, they are displayed alphabetically. Furthermore, certain types of files, such as emails, are not filed within the same folders, but remain in their separate environment, such as the email program. This is disadvantageous, as it makes it more difficult for someone to follow how the matter changed over time. Furthermore, it wastes paper, since in most cases users will print out a physical copy of each document to ensure that a matter file can be maintained.

### SUMMARY OF THE INVENTION

A method and apparatus for matter-centric document organization is described.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1A is a block diagram of one embodiment of a network on which the present invention may be implemented.

FIG. 1B is a diagram illustrating one embodiment of the functionality of the present invention.

FIG. 2A is an overview of one embodiment of the elements of the present invention.

FIG. 2B is a block diagram of one embodiment of the architecture of the present invention.

FIG. 3 is a block diagram of one embodiment of the matter-centric document management system.

FIG. 4 is a flowchart of one embodiment of creating a new matter file in the matter-centric document management system.

FIG. 5 is a flowchart of one embodiment of filing a new document in the matter-centric document management system.

FIGS. 6A and 6B are flowcharts of one embodiment of adding an email to the matter-centric document management system.

FIG. 7 is a flowchart of one embodiment of refilling objects in the matter-centric document management system.

FIG. 8 is an exemplary user interface, showing the unified front page for a user.

FIG. 9 is an exemplary user interface showing a virtual matter file.

FIG. 10 is an exemplary user interface showing the opening of a new virtual matter file.

FIG. 11 is an exemplary user interface showing the saving of a new document within a virtual matter file.

FIG. 12 is an exemplary user interface showing the email interface.

FIG. 13 is an exemplary user interface showing the search interface for the present invention.

FIG. 14 is an exemplary search screen, showing a search helper.

FIG. 15 is an exemplary user interface showing filed hierarchical search results.

FIG. 16 is a block diagram of a computer system on which the present invention may be implemented.

### DETAILED DESCRIPTION

A method and apparatus for matter-centric document management is described. The matter-centric document management system creates a single workspace for all information about a matter. This information, in one embodiment includes documents, correspondence, tasks, events, and discussions. In one embodiment, the workspace may further include people and time and billing reports. This electronic version of the case file uses the known paradigms of physical document management to incorporate all electronic data sources.

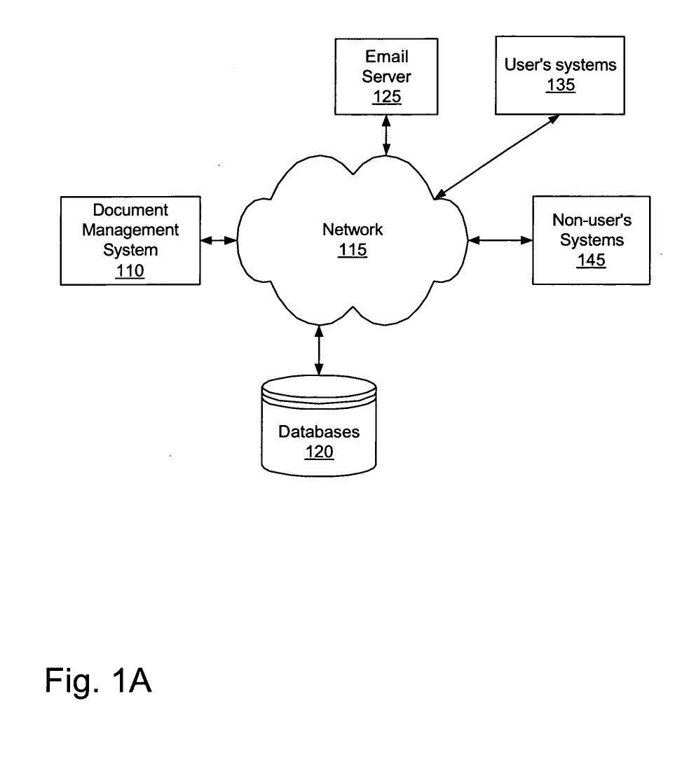

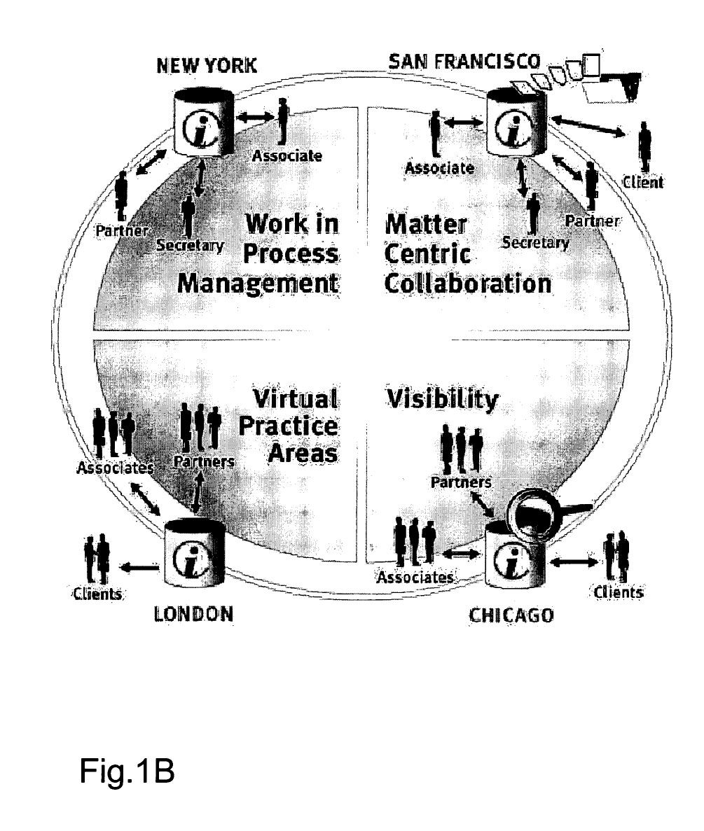

FIG. 1A is a block diagram of one embodiment of a network on which the present invention may be implemented. The document management system 110 may reside on a user's computer system, or may reside on a central server. It is coupled by network 115 to various user's computer systems 135. In one embodiment, each of the user's systems has a resident document management system. In another embodiment, the document management system is implemented on a central server 110, and the users' computer systems 135 include a client-side layer only, and interact with the server primarily.

In one embodiment, the data may be stored in databases 120 remote from the document management system 110, accessible through network 115. Email server 125 is also used to send emails, and sends copies of emails, as will be described, to the matter file.

In one embodiment, non-users systems 145, such as the systems of clients may be able to access the document management system 110 through the network 115 as well.

FIG. 1B is a diagram illustrating one embodiment of the functionality of the present invention. The document management system of the present invention connects various offices across the country, and across the world. The associates, partners and secretaries can share information with clients through the document management system.

Furthermore, external clients may access the system, or limited portions of the system as well. The system permits work in process management 150, matter centric collaboration 160, virtual practice areas 170, and visibility to everyone.

Work in process management 150 is accomplished using the matter folders described in more detail below. By collecting relevant information in a matter oriented format, and permitting subscription, work in progress can be managed and supervised.

Matter centric collaboration 160 permits collaboration between users in different locations, as well as between support staff, clients and attorneys.

Virtual practice areas 170 enable the user to set up formats and settings per practice area. For example, the document folders for an attorney working in technology licensing do not have the same items as the document folders for an attorney working with human resources issues. By enabling every type of practice area to optimize for appropriate settings, virtual practice areas can be set up.

Visibility 180 enables searching and access of files through the document management system. Furthermore, visibility may be provided to external users such as clients, on a permission basis.

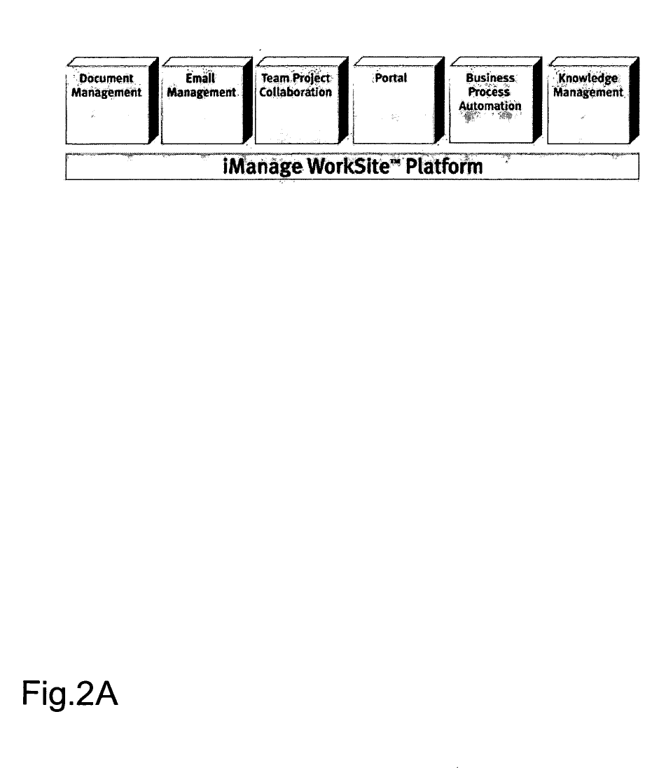

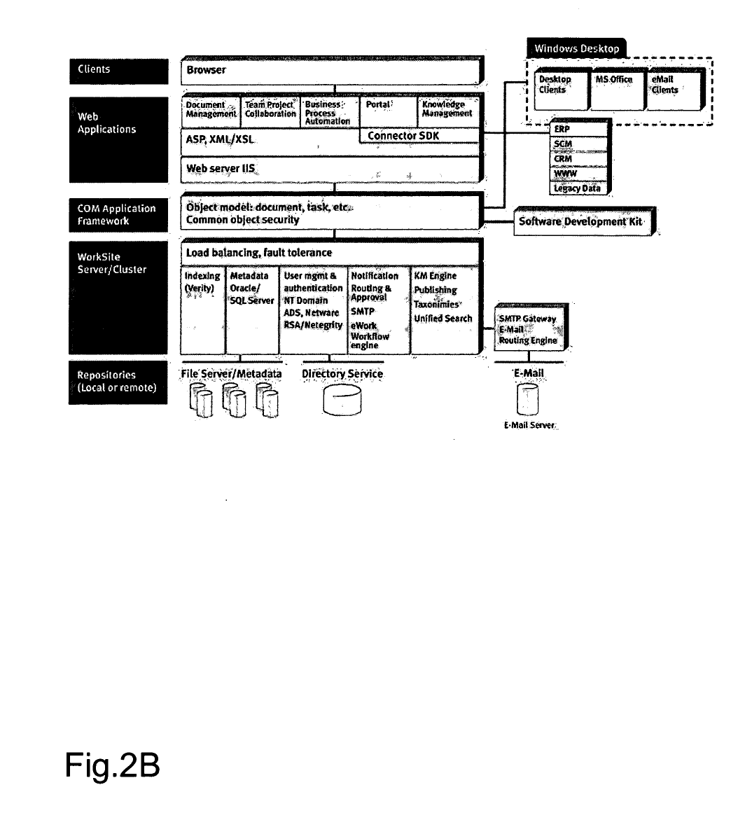

FIG. 2A is an overview of one embodiment of the elements of the present invention. The worksite platform 205 includes multiple elements.

Document management 210 is described in some detail below. The documents are organized in a repository, but displayed to the user in a matter-centric manner.

Email management 215, as will be described below, uses the ability to copy emails to a matter folder to keep a correspondence file in a matter file. The correspondence file further, in one embodiment, builds message threads, to enable the user to track exchanges.

Team project collaboration 220 enables team members to collaborate on working on documents and share in addition to document, collaborative items such as tasks, event, discussion threads, and contacts In one embodiment, team members may be outside the Worksite, i.e. external users.

The portal 225 enables third parties, who do not have the worksite, to access the data. In one embodiment, a user may provide permissions to external users to access certain portions or entireties of matter files. For example, an attorney may provide such access, through the portal to a client. For another example, an attorney may access the data from home, through the portal 225. Portal in 225 enables the system to integrate with third party system including time and billing, enterprise resource planning, customer relationship management, and news feeds.

Business Process Automation 230 enables the user to set up systems to follow business processes. For example, a system may be set up to automate the need to be reviewed by a supervisory partner. In this example, when the associate preparing the document completes the draft, the business process automation 230 may notify the partner and flag the item for the partner's review.

Knowledge management 235 enables visibility and the ability to reapply acquired knowledge through the system.

FIG. 2B is a block diagram of one embodiment of the architecture of the present invention. At the lowest level the system includes repositories 240, which include metadata 242, a directory service 244, and an email repository 246, which in one embodiment resides on the email server. The metadata 242 may reside in a file server, which may store documents as well. In one embodiment, the directory service 244 provides searching abilities to the system.

The server cluster 250, at the next higher level, includes: indexing 252, a metadata database 254, user management and authentication 256, SMTP and related routing, notification and workflow 258, searching and knowledge management 260. In one embodiment, the system further includes load balancing capabilities 262, which enable fault tolerance, such that services may fail over, if there are any software or hardware failures. In one embodiment, the server cluster 250 further includes an email facility 264, to enable email and routing.

The Common Object Model (COM) Application framework layer 270 includes object models, and common object security 272. In one embodiment, a software development kit (SDK) 274 interfaces to the COM application framework layer 270. The Windows Desktop Applications 276, including desktop clients 277, MS Office 277, and email clients 278 interface to the system at this level as well.

The Web Applications layer 280 includes multiple layers as well. The web applications layer includes a web server IIS 282, ASP, XML/XSL interfaces 284, and a connector SDK 284, to which various data sources may be coupled. The data sources may include ERP, SCM, CRM, the World Wide Web, and legacy data sources.

Above the ASP, XML/XSL layer 284 resides the worksite platform layers described above, document management 210, team project collaboration 220, business process automation 230, portal 225, and knowledge management 235.

At the highest level, the client 290 may be an email browser 282. The ability to use a standard browser for interface is advantageous. In another embodiment, a custom client may be used to interface into the system

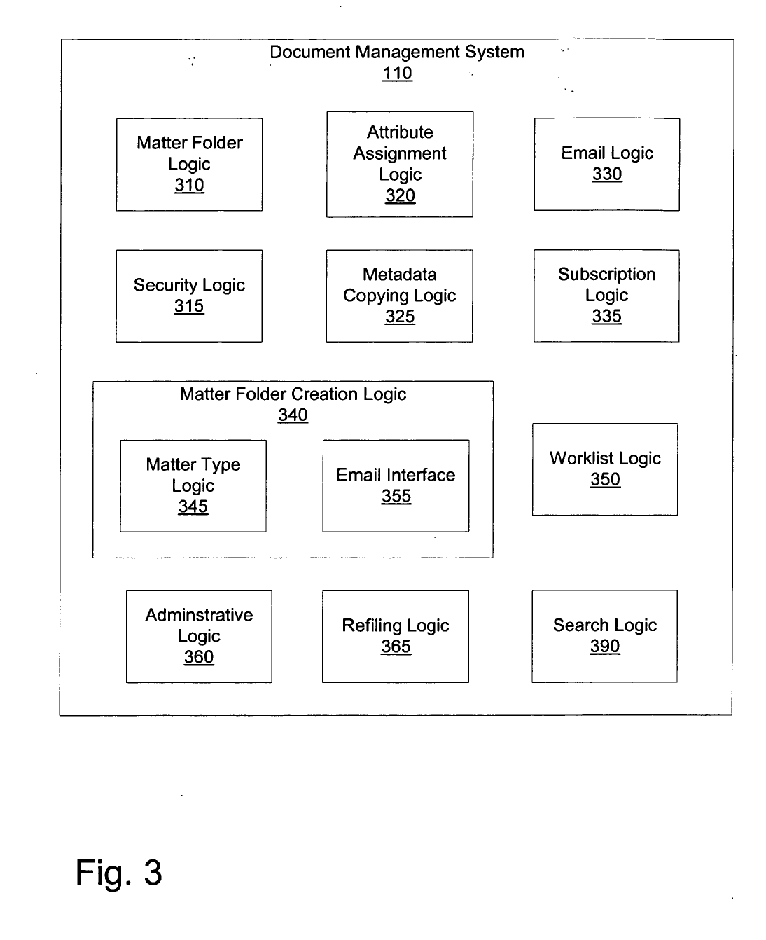

FIG. 3 is a block diagram of one embodiment of the matter-centric document management system. The system includes matter file logic 310 to enable the use of matter files. Matter files are created by matter file creation logic 340, and maintained and displayed by matter file logic 310. The matter file logic 310 uses the underlying data repository to create the user's preferred layout including the active matters, etc. In one embodiment, matter file logic 310 permits the user to arrange the matter files into a taxonomy or ontology based upon the metadata of the matter files.

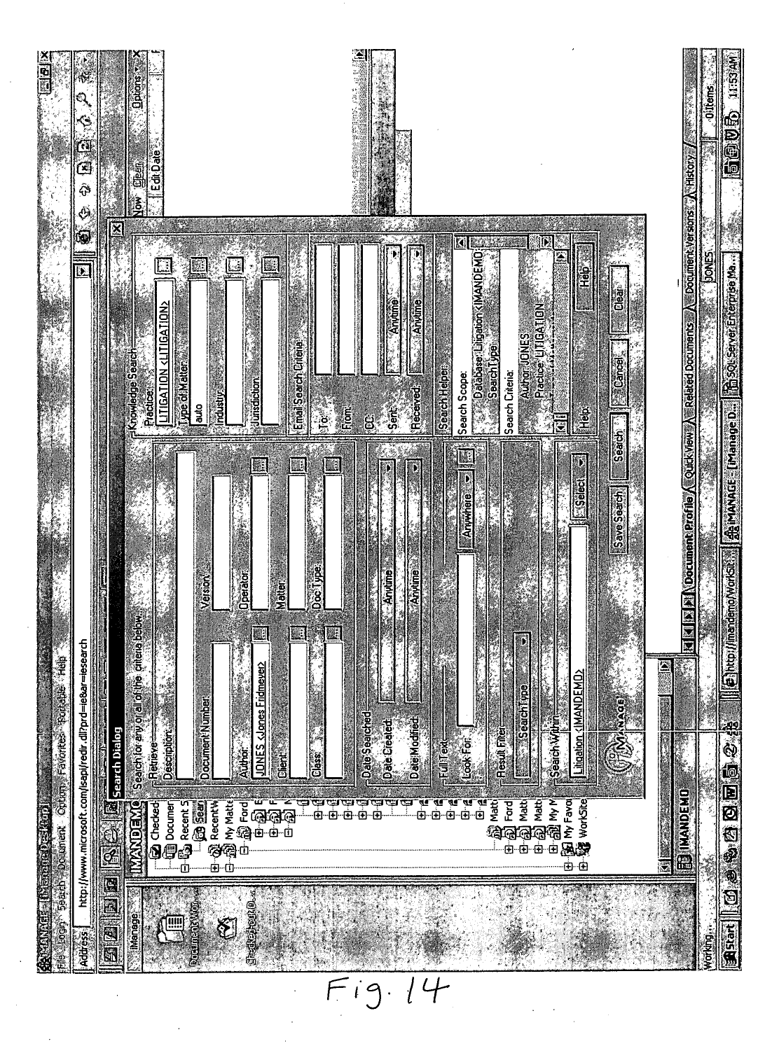

In one embodiment, search logic 390 allows searching and browsing of the matter files using the metadata. The search logic 390 further enables the browsing of folders within matter files, and search by metadata, across matter files and folders, or within a folder/context. In one embodiment, search logic includes a “search helper” which tells you what your search is, as you construct it. This ensures that the query actually represents what the user wishes to know. FIG. 14 is an exemplary interface showing the search helper.

Search logic 390 includes metadata and full text searching. In one embodiment, search results have security (i.e. only results to which you have access are searched or displayed). In one embodiment, the search syntax is saved, and the search results are hierarchical. For example, if a user searches across all Antitrust Matters, searches for the Sherman Act, Tying, and Collusion, the search logic 390 organizes the search results into a hierarchical format, so when the user browses the results, he or she can easily oversee the set of results, and see how individual results fit into the hierarchy. The search syntax, in one embodiment, are browsable. Saved search syntaxes may be integrated with other documents and folders.

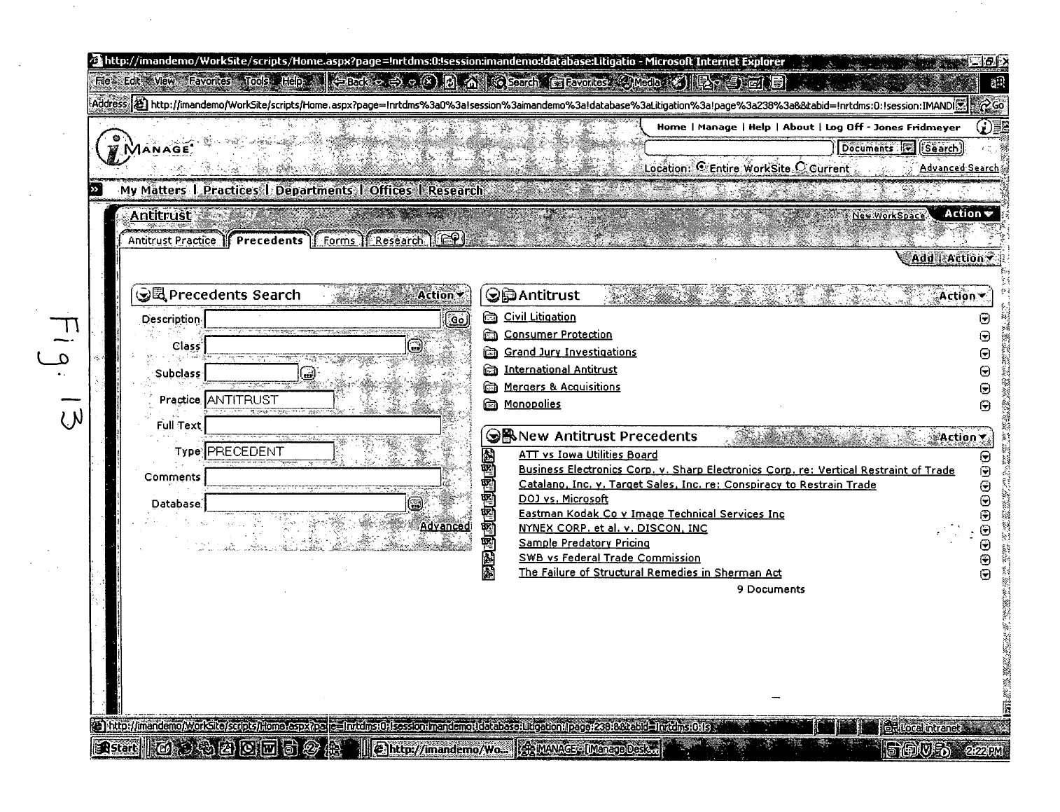

FIG. 13 illustrates an exemplary search result interface. As can be seen, the exemplary search was done for a document type in a practice area, document type Precedent, across practice area Antitrust. This search would search across matter folders, and across servers, seamlessly to the user.

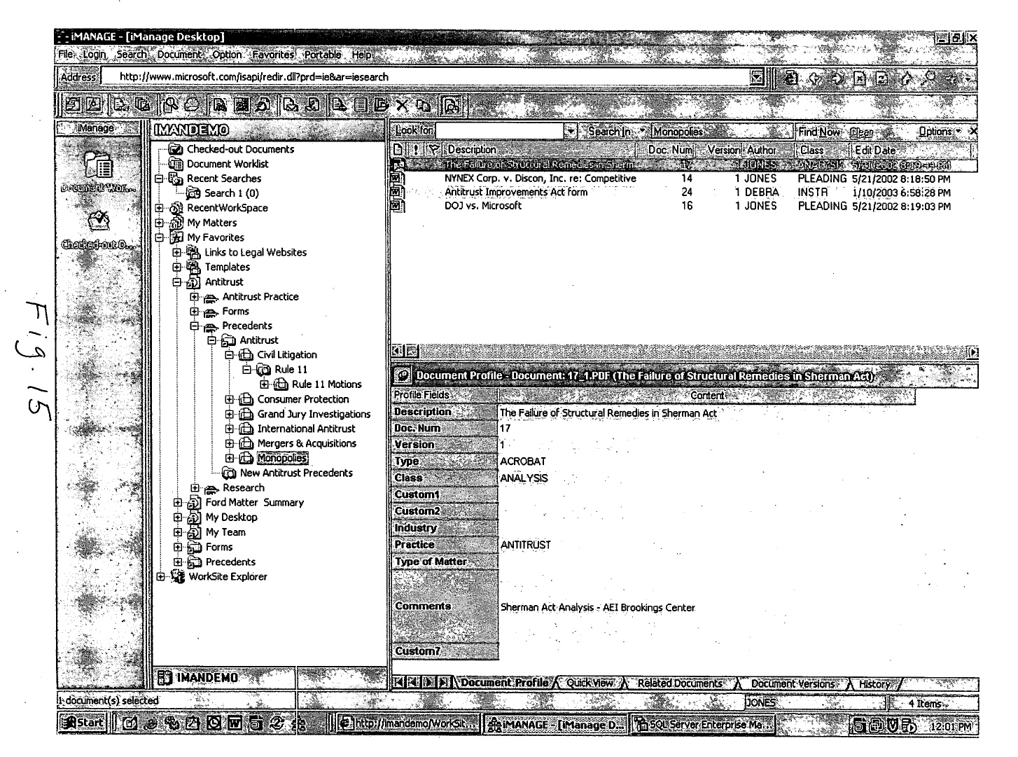

FIG. 15 is an exemplary interface showing a set of hierarchically saved search syntaxes. In one embodiment, the search results are not saved. However, the user can reexecute the search by simply selecting the search syntax. As can be seen, by hierarchically organizing the search results, the results can be more easily viewed.

The metadata includes: date of creation, date of closure, size of deal, etc. These metadata fields, in one embodiment, may be customized by a law firm. In one embodiment, the metadata fields may vary by matter type, and the matter files may be arranged by matter file logic 310 based on the metadata.

Matter folder creation logic 340 includes a matter type logic 345 and email interface 355. Matter type logic 345 receives a matter folder type from user, and creates the appropriate folders, subfolders, and metadata elements for the matter folder type. Matter folder creation logic 340 receives the list of users who will be working on this matter folder, and adds the new matter file to their Active Matters or My Matters list. In one embodiment, one or more of the users are provided an email notification of the creation of the matter folder. The email interface 355 creates an email address for the matter folder. In one embodiment, the email interface also adds the newly created email address to the user's email contact lists.

Worklist logic 350 tracks the last set matter files that the user has interacted with in the system. In one embodiment, the Worklist list logic 350 tracks the last set documents that the user has open, viewed, or saved. In one embodiment, 40 documents are tracked.

Security logic 315 permits the user to assign a level of security to a matter file. In general, documents within a matter file inherit the security level of the folder in which they reside. However, the user may, using security logic 315, assign a different security level. Furthermore, as will be described below, security logic 315 may warn a user if a document or file is shared with users outside the system.

Attribute assignment logic 320 creates the metadata fields for a document, or folder, based on folder or document category. In one embodiment, attribute assignment logic 320 permits a user to add further metadata fields to documents. Attribute assignment also assigns metadata to the matter file.

Metadata copying logic 325 copies the appropriate metadata from a parent folder to a child folder or child document. This reduces the number of fields a user must fill out.

Email logic 330 files emails received addressed to a matter file in the appropriate correspondence file. Email logic 330 furthermore reminds a user to copy the matter file, as described below in more detail.

Subscription logic 335 allows a user to subscribe to Matter Folders of other users, or the entire My Matters file. This feature is useful for supervision as well as working together. In one embodiment, subscription logic 335 has two levels of subscription. At a first level, referred to as subscription, a user subscribes to a particular matter file only. At a second level, referred to as Sharing, a user subscribes to the entire My Matters file of another user. This is especially useful in a supervisor/supervisee situation, where each party wishes to see the entire Workspace of the other. Each user decides as to whom they wish to share their My Matters. In one embodiment, a user share a variety of rights to their My Matters. A user could share only read only rights or a user can provide read/write access. The latter would be useful, for example, for a secretary who is subscribed to all of the relevant files, documents, and matter files on his or her attorney's computer.

Refiling logic 365 allows the refiling of objects into the matter folders, after creation outside the matter folders, or refiling from one matter folder to another.

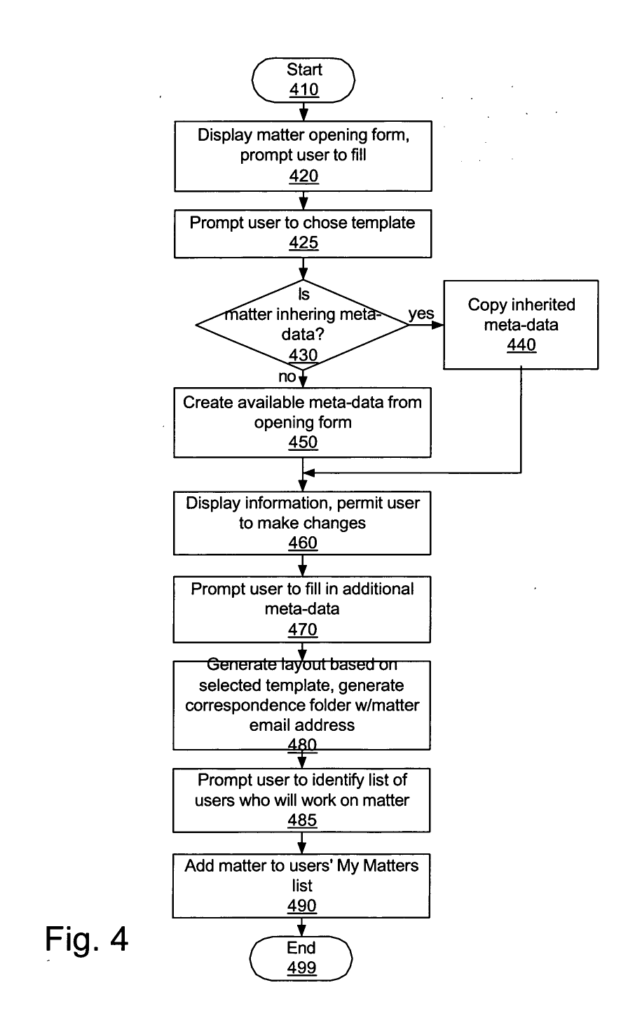

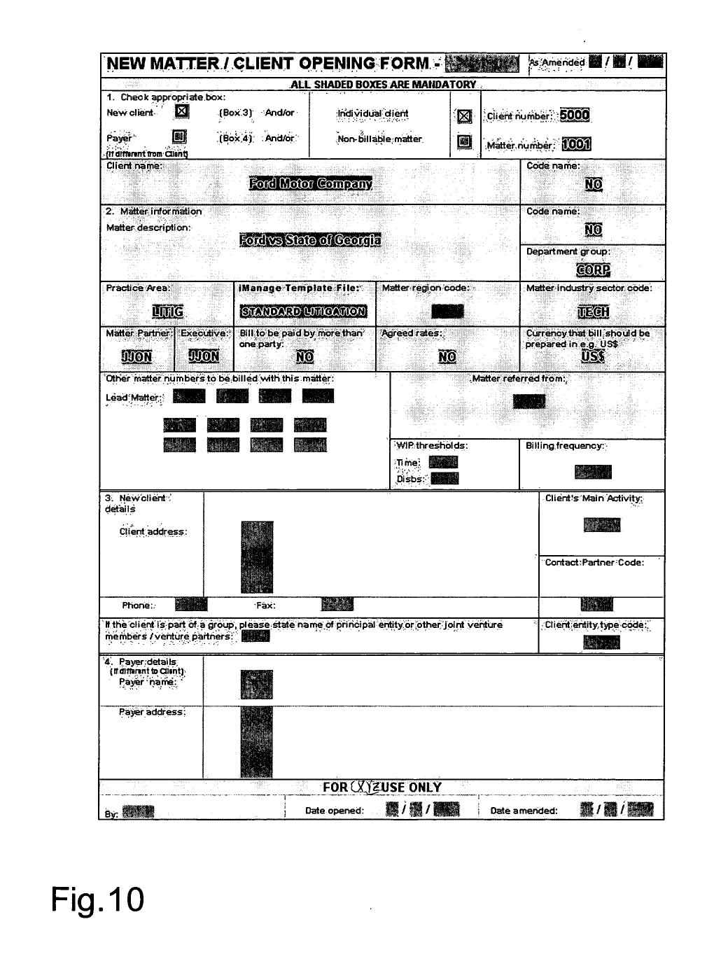

FIG. 4 is a flowchart of one embodiment of starting a new matter in the matter-centric document management system. The process starts at block 410. At block 415, the matter opening form is displayed, and the user is prompted to fill in the matter opening form. Various types of data are filled out. A completed matter opening form is shown in FIG. 10. As can be seen, the matter opening form permits the user to fill in various data, including the client name, practice area, etc.

Returning to FIG. 4, at block 425, the user is prompted to choose a template. As can be seen in FIG. 10, element 1050, the template file is selected. In one embodiment, the template files may include: standard litigation, patent litigation, employment litigation, licensing, sublicensing, general matter, etc. In one embodiment, the use may select a template file from a pull-down menu. In one embodiment, the set of template files may be created by an administrator or an authorized user. Thus, each user group may create its own set of templates. For example, a law firm may create a set of templates appropriate to its practice. In one embodiment, the system includes a set of “generic templates” which may be altered by authorized users. The templates include a plurality of metadata fields, applicable to the type of matter folder selected.

Furthermore, in one embodiment, in addition to the metadata fields based on the template used for the matter folder, the user may fill-out additional metadata fields. For example, for a litigation matter the user enter an insurance reserve amount, while in a corporate transaction, the deal size may be included. In one embodiment, the alteration of the metadata fields associated with a matter folder is done by an administrator.

At block 430, the process determines whether the new matter is inheriting metadata. A new matter inherits metadata if, for example, it is an existing client with existing procedures and existing client and billing data. If there is inherited metadata, the process, at block 440, copies the inherited metadata to the new matter. Otherwise, at block 450, the process creates the available meta-data from the form information. In one embodiment, various inherent metadata fields are also added to the matter file. For example, the metadata fields may include: date opened, date closed, reserve, deal size, etc. for a licensing matter. Various other metadata fields, relevant to the particular type of matter, may be assigned as well. The process then continues to block 460.

At block 460, the information is displayed, and the user is permitted to make changes. In one embodiment, the information that is displayed looks like the form shown in FIG. 10. The user may then alter any of the information he or she wishes, in one embodiment.

In one embodiment, information that was inherited, which is altered may trigger a query whether the underlying inherited information should be changed. For example, a user may change a billing address of a client, and the billing address is based on inherited metadata. In one embodiment, the system automatically queries whether the underlying information should be updated as well. In another embodiment, when a user makes a change, he or she may check a selection box indicating that the change should be propagated.

At block 470, the user is prompted to fill in any additional metadata, if needed. In one embodiment, certain data must be provided. For example, the client and billing information may be required in order to complete the form.

At block 480, a layout is generated based on the template. In one embodiment, a correspondence folder with an appropriate matter address is also generated. The matter address provides a simple way to copy messages to a matter folder. In one embodiment, the matter address reflects the matter information provided. Thus, for example, for the matter opening shown in FIG. 10, the display matter email address may be Ford vs. Georgia. In one embodiment, the actual address may be a random string generated for the matter. The domain, in one embodiment, is the domain of the user's system. When a message is sent to “Ford vs. Georgia” the message is actually sent to lkjas932874fwfs@domain.com, and it is filed in the correspondence folder of the user's matter file. This is described in more detail below.

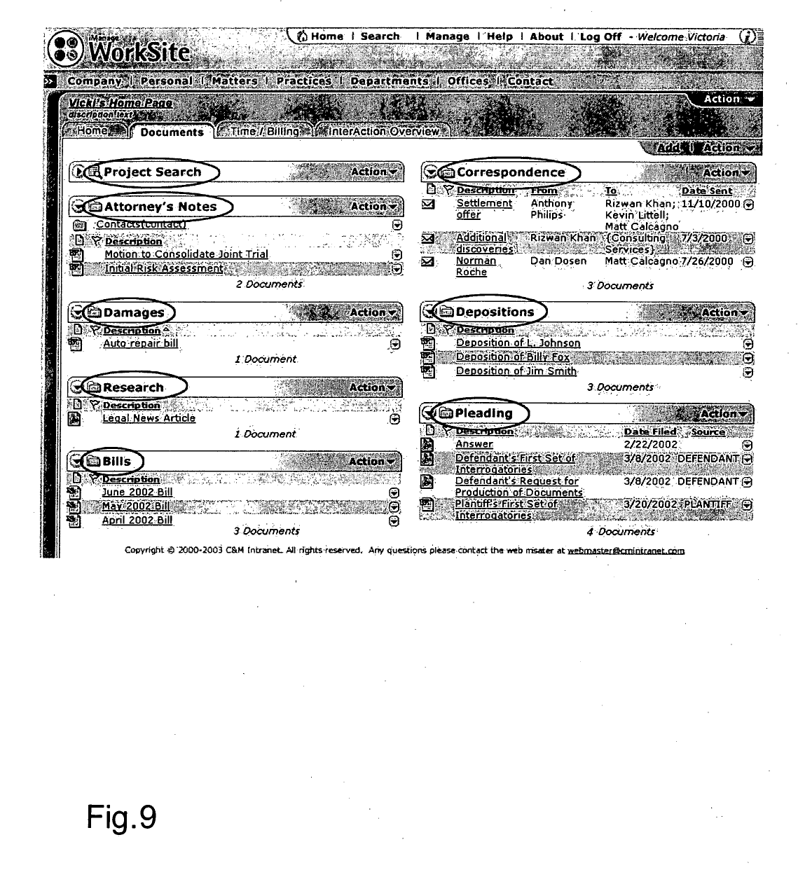

An exemplary layout for a matter is shown in FIG. 9. As shown in FIG. 9, the layout includes the elements that are part of the matter file. In this exemplary matter, the elements included are: project search, attorney notes, damages, research, bills, correspondence, depositions, and pleadings. As can be seen, this is a litigation file (as shown by the depositions and pleadings folder). The correspondence folder 950 receives any emails sent to the matter address.

Returning to FIG. 4, at block 485, the user is prompted to identify the list of users who will work on the matter. In one embodiment, the list of users includes all of the attorneys who will work on a matter. In one embodiment, secretaries, or support staff, are not included in this list, as they are subscribed to their bosses matters, as will be described above. In another embodiment, support staff may also be included in this list.

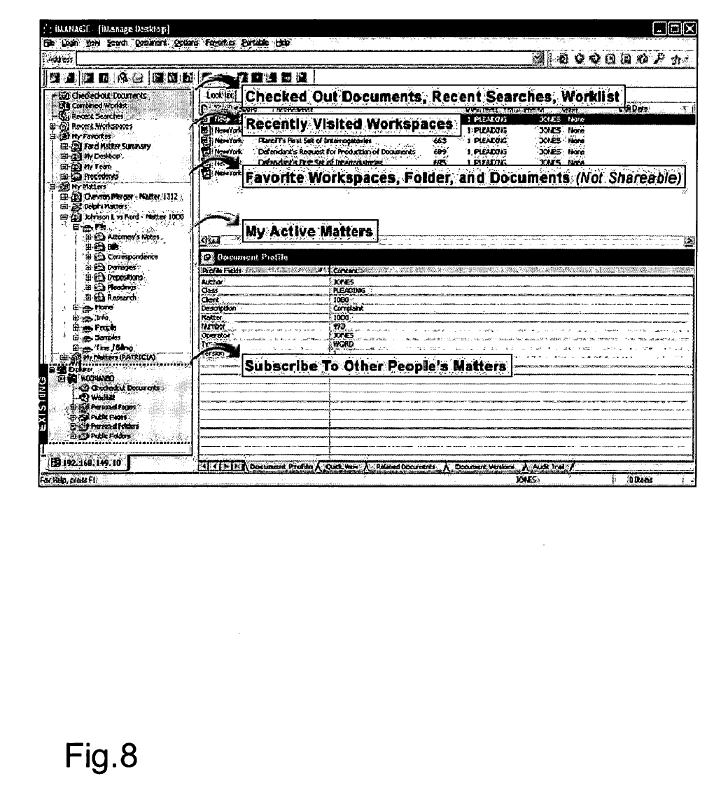

At block 490, the system automatically adds the new matter to the My Matters list for each of the users whose name was provided. As can be seen in FIG. 8, a user's workspace includes a list of Active Matters 810. When a user is designated as someone who will work on the matter, the matter is put into the user's Active Matters list 810. If the user were subscribed to someone's matter 820, that listing also would now include the new matter created.

The process then ends at block 499.

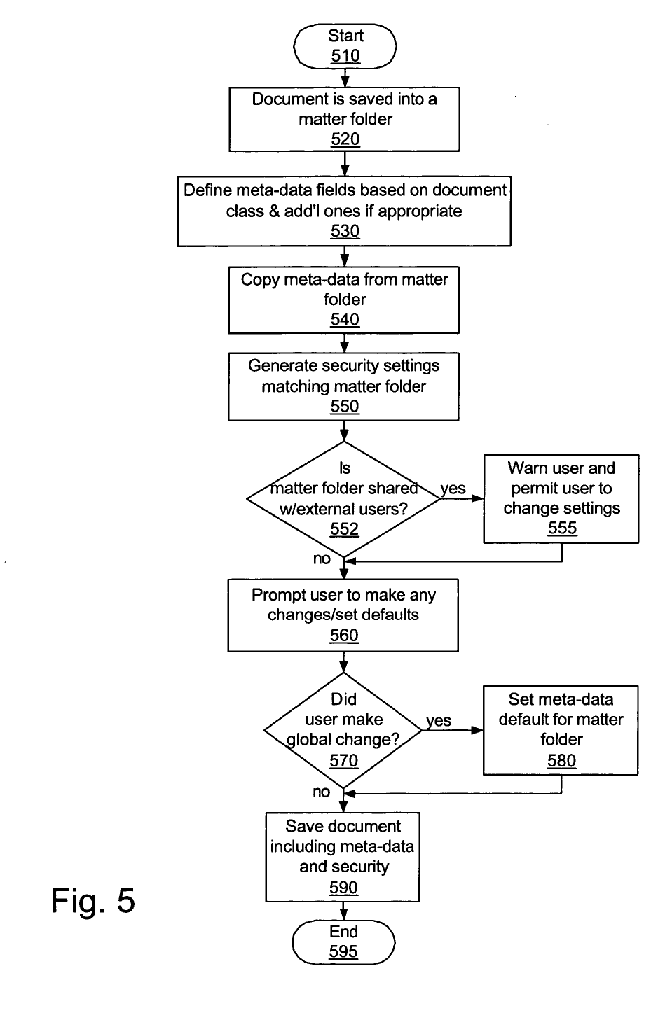

FIG. 5 is a flowchart of one embodiment of filing a new document in the matter-centric document management system. The process starts at block 510. At block 520, a document is saved into a matter folder.

At block 530, the set of metadata fields are defined, based on a document class. The document class is defined based on a location to which the document is saved. As can be seen in FIG. 9, each document type is separately filed. Thus, the document class may be Depositions, Pleadings, Attorney Notes, Research, etc. In one embodiment, a matter file may include an additional “catch-all” folder for uncategorizable items.

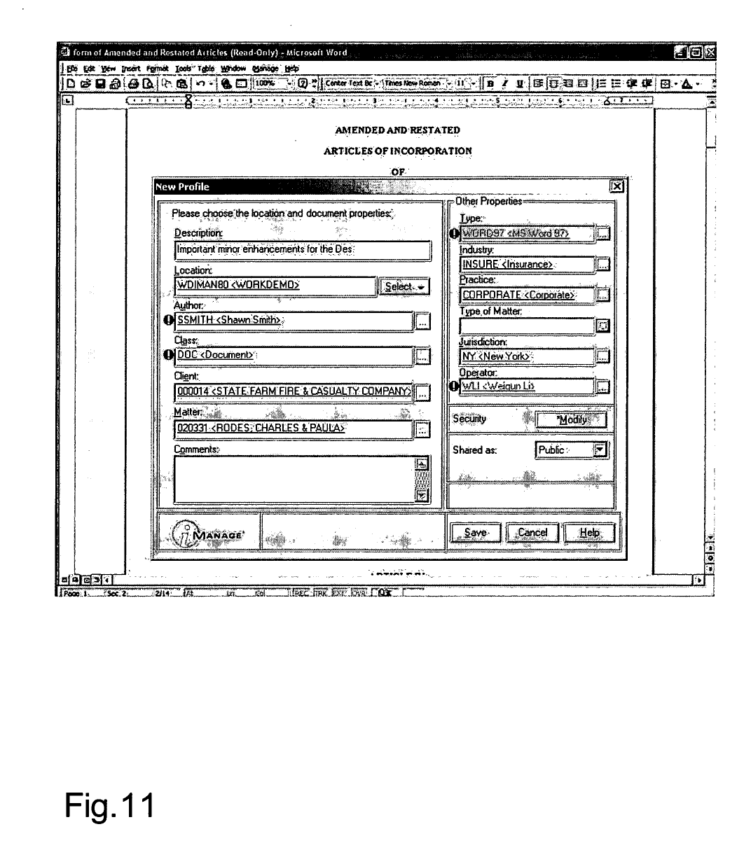

At block 540, metadata is copied from the matter folder. For example, the metadata includes the client name, location, matter, document type, etc. In another embodiment, metadata is inferred from the matter folder onto document without copying. Inferring, or inheriting metadata means that the metadata is not copied, but instead the metadata field is effectively pointed to the parent folder's metadata, so that when the parent folder's metadata is changed, the document's metadata automatically changes correspondingly. In one embodiment, if metadata is copied, not inferred, the system may automatically propagate the new metadata to the folders and documents under the changed folders. FIG. 11 illustrates one embodiment of the listed metadata associated with a document.

At block 550, the security settings generated for the new document, matching the security settings of the matter folder. The default security setting for any document is identical to that of the matter folder in which it resides. However, the user may change these defaults.

At block 552, the process determines whether the matter folder is shared with external users. External users may include clients, outside attorneys, or anyone not within the organization to which the user belongs. If the matter folder is shared with external users, the process continues to block 555. Otherwise, the process continues directly to block 560. In one embodiment, a visual indicator, such as an icon, is attached to the document to indicate that it is shared with external users.

At block 555, the user is warned of the sharing, and is permitted to change settings. For example, while a client may be allowed access to a matter folder, certain attorney notes may be kept from the client. By actively warning the user that the matter is shared—and in one embodiment, listing the users with whom the matter is shared in the warning—the user can trivially adjust the security settings of the particular document being saved.

At block 560, the user is prompted to fill in additional metadata, make any changes to the metadata that was auto-filled, and alter security settings if appropriate.

At block 570, the process determines whether the user made any global changes. In one embodiment, in addition to being able to change the local settings for a particular document, the user may indicate that any of the changes are global. For example, the security settings may be changed for the entire matter. The client name and other information can be changed globally as well. In one embodiment, each metadata item may have a checkbox to indicate that a change made to the metadata item in this document should be applied globally.

If the user made global changes, the metadata default for the folder is changed, at block 580.

The document and the associated metadata and security settings are then saved, at block 590. The process then ends at block 595. In one embodiment, this copy of the document is uploaded to a central server, and maintained there. In another embodiment, the “central server” is a distributed database of documents, which are accessible through one central address, but maintained in multiple locations.

In one embodiment, whenever someone who has access to the document wishes to view of edit it, a copy of the document is sent to the user. In one embodiment, a copy of the document is cached in a local server when it is accessed for viewing or editing. When a user checks in a document, the upload caching system first uploads to the local server, and the local server then uploads it to the central server. This means that from the user's perspective the saving process is faster and easier, and feels like the data is stored on a local server. The system, in one embodiment, further retains document versions, which enable tracking of the changes made to a document over time. Thus, when a user uploads an edited version of a document, the original document is retained as well. In one embodiment, the document retention policy may be altered to suit the company or law firm policy regarding retention.

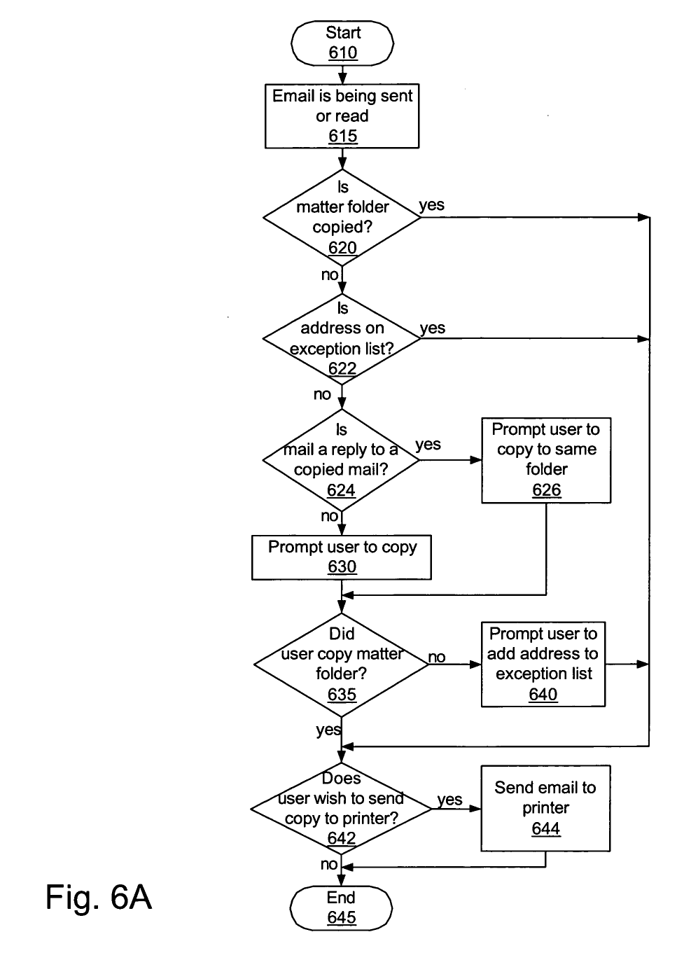

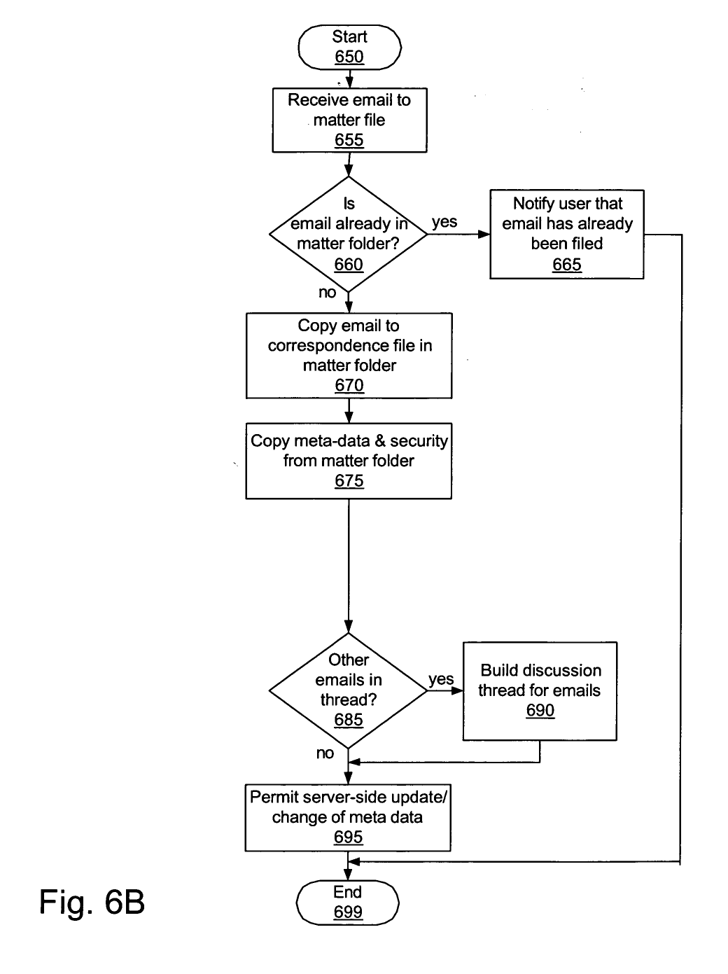

FIGS. 6A and 6B are flowcharts of one embodiment of adding an email to the matter-centric document management system. FIG. 6A illustrates a flowchart of one embodiment of handling email as it is being sent or read. The process starts at block 610.

At block 615, the process determines that an email is being sent or read. An email is considered “read” when a user opens it. An email is considered “sent” when a user clicks “Send” or otherwise indicates that the email should be sent.

At block 620, the process determines whether a matter folder is copied on the email. Copied in this instance may mean sending a carbon copy or a blind carbon copy of the email to the matter folder. If a matter folder is copied, the process continues directly to block 642. If no matter folder is copied, the process continues to block 622.

At block 622, the process determines whether the address is on an exception list. The address, if it is an email being read is the originator's address, while for an email being sent, the address is a destination address. The use of exclusion lists removes the matter reminder every time a user sends an email to a friend, a mailing list, or another persistent address that is not related to any matter. If the mail is on an exception list, the process continues directly to block 642. Otherwise, the process continues to block 624.

At block 624, the process determines whether the mail is being sent in response to a mail that was copied to a matter folder. If so, the process, at block 626, prompts the user to copy the same matter folder.

If the mail is not a response to a copied mail, then the process, at block 630, prompts the user to copy a matter folder. In one embodiment, a dialog box may be displayed, listing all of the currently active matter email addresses for the user. The user may then select the appropriate matter folder to copy. Note that while the “display” name of a matter folder may be something like “Ford v. Georgia,” in one embodiment the underlying email address may be a string, which is difficult to duplicate and is assigned randomly. This ensures that matter folders are not spammed, and that a large number of matters may be easily tracked without confusion.

At block 635, the process determines whether the user copied a matter folder. If so, the process continues to block 642. Otherwise, at block 640, the user is prompted to add the address to the exception list, so that future emails to this address are not prompted for copying. In one embodiment, a dialog box is displayed simply querying whether the user wishes to add the target email address (in one embodiment display in the dialog box) to the list of excluded email addresses. The user simply can choose to click Yes or No.

At block 642, the process queries the user whether he or she wishes to send a copy of the email to the printer. In one embodiment, this is indicated through a selection at the time the email is sent or opened for reading. In one embodiment, this feature may be disabled by the system administrator. However, the ability to easily print emails may be important, as for example in England, where physical printouts of emails are required. If the user chooses to send a copy of the email tot eh printer, the system does so at block 644. The process then ends at block 645.

FIG. 6B is a flowchart of one embodiment of processing when an email is received in a matter folder. The process starts at block 650, and at block 655, an email is received to the matter folder. The email may be sent only to the matter folder, or may be copied (cc or bcc) to the matter folder.

At block 660, the process determines whether the email is already in the matter folder. The email may already be in the matter folder, for example, if it was BCC'd by a sender and then sent as a copy by the recipient, or if it was not copied by a sender, but sent in as copies by multiple recipients.

If the email is already in the folder, in one embodiment the user may be notified of this at block 665. The process then ends at block 699. Notifying the user may be optional. In another embodiment, a user may request that he or she not be notified if an email has already been filed.

If the email is not in the matter folder, the process continues to block 670. At block 670, the email is copied to the correspondence file in the matter folder.

At block 675, the metadata and security information is copied for the matter folder, and associated with the email. In one embodiment, additional information that is obtained from the email itself is also added to the metadata. For example, the additional information may include the To, From, and CC (and BCC for emails sent by the user) for the mail message.

At block 685, the process determines whether there are other emails in the thread. If there are other emails in the thread, the process continues to block 690. At block 690, a discussion thread is built from the emails. This enables a user, on reviewing the matter folder, to easily see the emails, responses, and evolution of messages over time.

At block 695, server-side updates and changes to the metadata are permitted. That is, the user is permitted to make changes to the metadata of the email once it is filed. The process then ends at block 699.

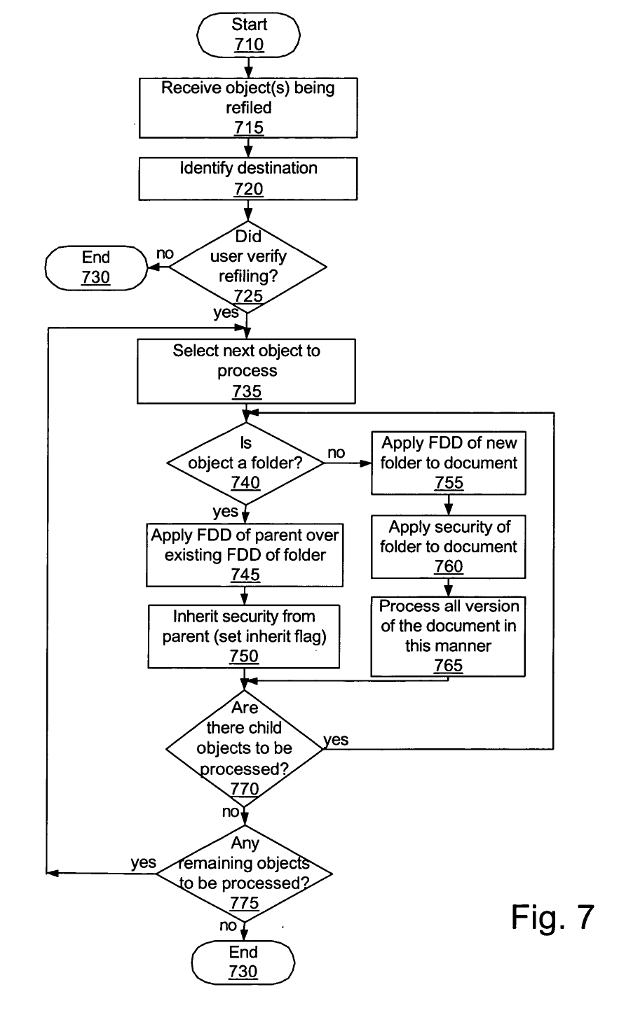

FIG. 7 is a flowchart of one embodiment of refilling objects in the matter-centric document management system. Documents, files, and folders may be refiled, for example, when the system is initially launched, and a user is attempting to add existing files into the system. Refiling may also come up if objects created outside the system are added in bulk. Additionally, if two matters are merged, or within the system if one or more folders or documents are moved from one matter folder to another, refiling may be used.

At block 715, objects are received for refiling. In one embodiment, objects may be dragged & dropped onto the matter-centric document management system. For example, a user may drag & drop objects into a matter folder. Alternatively, in one embodiment, a user may right click on an object and select “refile.” In another embodiment, a user may select “save as” for example for a set of files obtained from a Zipped object. Other methods of indicating that objects should be moved into the matter-centric document management system may be used.

At block 720, the destination is identified. In a drag & drop situation, the location where the objects are dropped is clear. However, if a user, for example, attempts to drop a file into a closed matter folder, or into the system as a whole, in one embodiment, the user is prompted to select a particular matter folder to which the objects should be added.

At block 725, the user is prompted to verify the refiling. If the user does not verify, the process terminates t block 730. If the user verifies that he or she wishes to refile the selected objects, the process continues to block 735.

At block 735, the next object is selected for processing. In one embodiment, the objects are processed in hierarchical order. That is, the highest level folder is processed, then any folders within the highest level folder, then any documents within the highest level folder, and so on. The system selects the highest level object available. In one embodiment, if all objects are the same level, the next object is selected by size.

At block 740, the process determines whether the object is a folder. If so, the process continues to block 745. If the object is not a folder, the process continues to block 755.

At block 745, the folder's default document profile (FDD) of the parent is applied over the existing FDD of the folder. In one embodiment, the FDD of the folder is deleted, and the new FDD is applied. In another embodiment, the new FDD is applied over the old, replacing any elements that exist in the new FDD, but retaining non-duplicated elements.

At block 750, security for the folder is inherited from the parent. Folders, in one embodiment, have an inherit flag, which indicates whether they have an inherited security level. If the inherit flag is set, in one embodiment, the folder does not have its own security settings, but rather has the same security settings as the parent folder. This means that if the parent folder's security settings are later changed, the folder with the inherit flag set also automatically changes its security settings. The folder is now processed, and the process continues to block 770.

If the object was not a folder, at block 740, the process continued to block 755. At block 755, the FDD of the new folder is applied to the document. In one embodiment, the existing metadata associated with the folder does not change, except if the FDD overrides it. That is, the metadata of the document becomes: existing metadata+FDD, with the FDD overwriting any metadata it encounters.

At block 760, the security of the folder is applied to the document. In one embodiment, this is not “inherited” security. Thus, the document retains this level of security even if it is moved, or if the folder's security is changed.

At block 765, all versions of the document are processed in this manner. In one embodiment, the system may save multiple versions of a single document. In one embodiment, the system automatically processes all versions of the document, even if only the latest version was moved. In another embodiment, the user may choose whether other versions of the document should also be processed. For example, the user may choose to only change the information and filing location of the most recent version. The document processing is then complete, and the process continues to block 770.

At block 770, the process determines whether there are any child objects to be processed. If there are child objects to be processed, the process returns to block 740. If there are no child objects to be processed, the process continues to block 775. At block 775, the process determines whether there are any more objects to be processed. If so, the process returns to block 735, to select the next object to process. If there are no more objects to be processed, the process ends at block 730.

FIG. 8 is an exemplary user interface, showing the unified front page for a user. As can be seen, the listing on the left hand side includes a number of areas. The Active Matters 810 lists all of the matters to which the user is subscribed. As can be seen, in one embodiment, the tree structure of Windows Explorer may be used. Alternative display formats may be selected.

In addition to Active Matters 810, the user may have a list of Subscribed Matters 820. Subscribed Matters 820 represent matters in other people's folders. For example, an executive assistant may subscribe to his or her bosses' matters. A partner may subscribe to the matters handled by associates supervised by the partner, etc. The Subscribed Matters 820, in one embodiment, are organized by owner.

The front page may further include a list of Favorites 850. Favorites 850 may include matter files, folders, folders organized by taxonomies such as “Best Practices,” and particular documents. Favorites 850 may cut across multiple databases. In one embodiment, Favorites 850 are not shareable. The Favorites 850 may be shortcuts to Workspaces, Folders, and Documents selected by the user. The shortcuts may cut across servers, and databases transparently to the user.

Recently Visited 840 enables easy returns to previously visited Workspaces. FIG. 9 illustrates an exemplary Workspace.

Active Items 830 includes checked out documents, recent searches, and Worklist. In one embodiment, documents are kept in a repository, and may be checked out for editing. Checked out documents include a list of documents currently checked out by the user. Recent searches allow a user to re-execute a search. Worklist is a list of documents recently opened by the user. The Worklist may include documents that do not belong to the user.

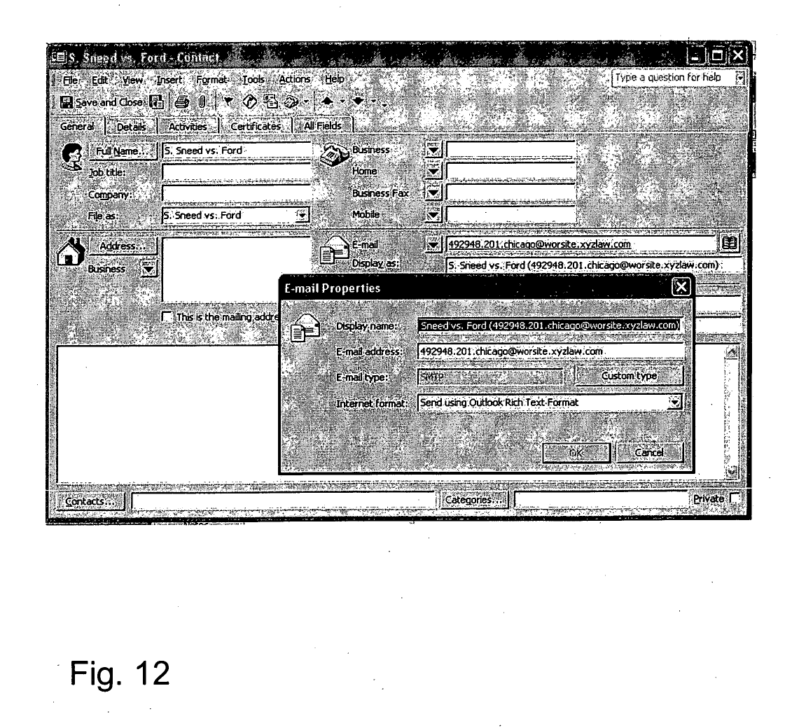

FIG. 12 is an exemplary user interface showing the email interface. In one embodiment, as described above with respect to FIG. 4, the system automatically adds an email address for a newly opened matter. In another embodiment, the user may manually add an email address for a matter folder.

When the email address is added, additional contact information may be added. Furthermore, as can be seen, the display name reflects the matter identifier. However, as can be seen, the actual email address which is referenced is a long string, to ensure that the matter folder will not be spammed, and to ensure no cross-contamination between matter folders. For example, in a law firm, two lawyers in different offices may be working on entirely different licenses, for example one to Apple Computer and one to Apple Records. The term Apple Licensing, were it used as an email address, would potentially be misfiled. However, each attorney would only have the Apple Licensing address that corresponded to his or her own files. Therefore, the system would be able to correctly file correspondence, in spite of the name overlap.

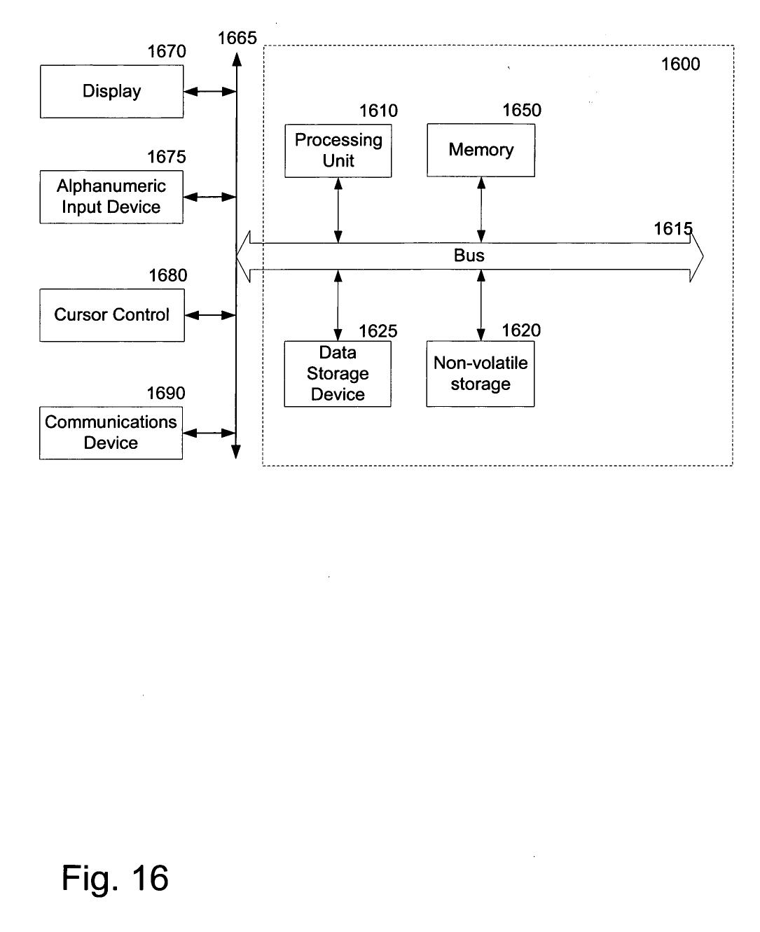

FIG. 16 is one embodiment of a computer system that may be used with the present invention. It will be apparent to those of ordinary skill in the art, however that other alternative systems of various system architectures may also be used.

The data processing system illustrated in FIG. 16 includes a bus or other internal communication means 1615 for communicating information, a processor 1610 coupled to the bus 1615 for processing information. The system further comprises a random access memory (RAM) or other volatile storage device 1650 (referred to as memory), coupled to bus 1615 for storing information and instructions to be executed by processor 1610. Main memory 1650 also may be used for storing temporary variables or other intermediate information during execution of instructions by processor 1610. The system also comprises a read only memory (ROM) and/or static storage device 1620 coupled to bus 1615 for storing static information and instructions for processor 1610, and a data storage device 1625 such as a magnetic disk or optical disk and its corresponding disk drive. Data storage device 1625 is coupled to bus 1615 for storing information and instructions.

The system may further be coupled to a display device 1670, such as a cathode ray tube (CRT) or a liquid crystal display (LCD) coupled to bus 1615 through bus 1665 for displaying information to a computer user. An alphanumeric input device 1675, including alphanumeric and other keys, may also be coupled to bus 1615 through bus 1665 for communicating information and command selections to processor 1610. An additional user input device is cursor control device 1680, such as a mouse, a trackball, stylus, or cursor direction keys coupled to bus 1615 through bus 1665 for communicating direction information and command selections to processor 1610, and for controlling cursor movement on display device 1670.

Another device, which may optionally be coupled to computer system 1600, is a communication device 1690 for accessing other nodes of a distributed system via a network. The communication device 1690 may include any of a number of commercially available networking peripheral devices such as those used for coupling to an Ethernet, token ring, Internet, or wide area network. The communication device 1690 may further be a null-modem connection, or any other mechanism that provides connectivity between the computer system 1600 and the outside world. Note that any or all of the components of this system illustrated in FIG. 16 and associated hardware may be used in various embodiments of the present invention.

It will be appreciated by those of ordinary skill in the art that any configuration of the system may be used for various purposes according to the particular implementation. The control logic or software implementing the present invention can be stored in main memory 1650, mass storage device 1625, or other storage medium locally or remotely accessible to processor 1610.

It will be apparent to those of ordinary skill in the art that the system, method, and process described herein can be implemented as software stored in main memory 1650 or read only memory 1620 and executed by processor 1610. This control logic or software may also be resident on an article of manufacture comprising a computer readable medium having computer readable program code embodied therein and being readable by the mass storage device 1625 and for causing the processor 1610 to operate in accordance with the methods and teachings herein.

The present invention may also be embodied in a handheld or portable device containing a subset of the computer hardware components described above. For example, the handheld device may be configured to contain only the bus 1615, the processor 1610, and memory 1650 and/or 1625. The handheld device may also be configured to include a set of buttons or input signaling components with which a user may select from a set of available options. The handheld device may also be configured to include an output apparatus such as a liquid crystal display (LCD) or display element matrix for displaying information to a user of the handheld device. Conventional methods may be used to implement such a handheld device. The implementation of the present invention for such a device would be apparent to one of ordinary skill in the art given the disclosure of the present invention as provided herein.

The present invention may also be embodied in a special purpose appliance including a subset of the computer hardware components described above. For example, the appliance may include a processor 1610, a data storage device 1625, a bus 1615, and memory 1650, and only rudimentary communications mechanisms, such as a small touch-screen that permits the user to communicate in a basic manner with the device. In general, the more special-purpose the device is, the fewer of the elements need be present for the device to function. In some devices, communications with the user may be through a touch-based screen, or similar mechanism.

It will be appreciated by those of ordinary skill in the art that any configuration of the system may be used for various purposes according to the particular implementation. The control logic or software implementing the present invention can be stored on any machine-readable medium locally or remotely accessible to processor 1610. A machine-readable medium includes any mechanism for storing or transmitting information in a form readable by a machine (e.g. a computer). For example, a machine readable medium includes read-only memory (ROM), random access memory (RAM), magnetic disk storage media, optical storage media, flash memory devices, electrical, optical, acoustical or other forms of propagated signals (e.g. carrier waves, infrared signals, digital signals, etc.).

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

1. A matter-centric document management system (DMS) comprising:
a matter file including a plurality of folders, each folder corresponding to a document type; and
an attribute assignment logic to automatically create metadata data fields for a new document, when the new document is placed in a folder, the metadata fields appropriate for the document type.

2. The DMS of claim 1, further comprising:
an metadata copying logic to automatically fill in the metadata fields which correspond to metadata fields in a parent folder.

3. The DMS of claim 1, further comprising:
a security logic to assign a security level to the document, the security level corresponding to a security level of a parent folder.

4. The DMS of claim 1, further comprising:
a matter creation logic to create a new matter folder, the matter creation comprising:
matter type logic to receive a matter type selection from a user, and to create a plurality of folders within the new matter folder, each folder corresponding to a document type.

5. The DMS of claim 4, wherein the matter creation logic further comprises:
a work list logic to receive a list of users for the new matter folder, and to add the new matter folder to a My Matters folder for the list of users.

6. The DMS of claim 4, wherein the matter creation logic further comprises:
an email interface to generate an email address for the matter folder, the email address to receive emails and file them in a correspondence folder in the matter folder.

7. The DMS of claim 6, wherein the email address comprises:
a display address closely related to a matter folder name; and
an actual address corresponding to the display address, the actual address being a unique string.

8. The DMS of claim 1, further comprising:
a subscription logic to enable a user to subscribe to a matter file, the subscription putting a copy of a matter file in the user's My Matters list.

9. The DMS of claim 8, wherein the subscription logic enables a user to subscribe to a matter file at a second level, wherein the subscription includes the matter file and documents and other folders.

10. The DMS of claim 8, where the subscription logic enables a user to subscribe to another user's subscription list and the user may be granted rights to modify another user's subscription list.

11. The DMS of claim 1, further comprising:
an email logic to file emails in an appropriate matter file.

12. The DMS of claim 11, further comprising:
the email logic to prompt a user to send a copy of an email to the matter folder.

13. The DMS of claim 1, further comprising:
a matter file logic to arrange the matter file into a taxonomy based on the metadata of the matter file.

14. The DMS of claim 1, further comprising:
a matter file logic to arrange the matter file into an ontology based on attributes of the matter file.

15. The DMS of claim 1, further comprising:
a refiling logic to simplify moving a plurality of objects into a matter folder by propagating the metadata to each of the objects in a hierarchical manner.

16. A method of implementing a matter-centric document management system comprising:
having a plurality of templates, each template designed to set up a matter file including a plurality of folders, each folder corresponding to a document type; and
setting up a matter file in response to a user request, the matter file including the plurality of folders; and
automatically creating metadata data fields for a new document filed in one of the plurality of folders in the matter file, the metadata fields appropriate for the document type.

17. The method of claim 16, further comprising:
the document inheriting metadata information from the one of the plurality of folders into which the document is filed.

18. The method of claim 17, wherein the inherited metadata is inferred.

19. An apparatus comprising:
a server to maintain data; and
a user system to display a Workspace to a user, the workspace including a plurality of matter files, each matter file including a plurality of folders, each folder corresponding to a document type; and
an email interface to generate a matter folder email address, the email interface to receive emails directed to the matter folder email address and file them in a correspondence folder in the matter folder.

20. The apparatus of claim 19, further comprising:
an attribute assignment logic to automatically create metadata data fields for a new document, when the new document is placed in a folder, the metadata fields appropriate for the document type.
